(19) United States
(12) Patent Application Publication
(10) Pub. No.: US 2011/0233410 A1
(43) Pub. Date: Sep. 29, 2011

(54) APPARATUS AND METHOD OF TESTING FILLED CONTAINERS FOR FOREIGN BODIES

(75) Inventor: Anton NIEDERMEIER, Offenstetten (DE)

(73) Assignee: KRONES AG, Neutraubling (DE)

(21) Appl. No.: 13/069,365

(22) Filed: Mar. 22, 2011

(30) Foreign Application Priority Data
Mar. 23, 2010 (DE) 10 2010 012 570.9

(51) Int. Cl. G01T 1/00

(52) U.S. Cl. 250/358.1; 250/395

(57) ABSTRACT

An apparatus for the inspection of filled containers may include a first radiation device which directs radiation onto the liquid to be tested and present in the container, and an image-recording device which records at least part of the radiation directed from the first radiation device onto the liquid and reflected or scattered by the container. The image-recording device may be designed for recording a spatially resolved image, wherein the apparatus has at least one further radiation device or one further image-recording device. The radiation devices and the image-recording device are arranged in such a way that an observation of the liquid is carried out on at least two image-recording paths which are different from each other.

### CROSS-REFERENCE TO RELATED APPLICATION

This application claims the benefit of priority of German Patent Application No. 10 2010 012 570.9, filed Mar. 23, 2010, pursuant to 35 U.S.C. 119(a)-(d), the disclosure of which is incorporated herein by reference.

### TECHNICAL FIELD

The present disclosure relates to a method and an apparatus for inspecting filled containers and, in particular, to a method and an apparatus for testing filled containers for foreign bodies.

### BACKGROUND

Inspection apparatuses, which test filled containers for impurities such as for example glass splinters, are known from the prior art. In this way, DE 102 577 49 B4 describes an inspection machine which tests the filled and closed containers for impurities such as for example glass splinters. In this case the container is first set in rotation about its own axis until the product, i.e. the liquid follows the rotation at least in part. After that, the container is stopped, and the liquid continues to rotate. The container is illuminated in this state and is observed by means of a camera. The movement of the liquid cannot be seen in the camera image, but the impurity and the movements thereof, on the other hand, can be. Within the scope of these descriptions impurities are to be understood as being inter alia glass splinters or other solid substances which are not desired in the product. Particularly dangerous for the end-consumer are glass splinters. In the case of DE 102 577 49 B4 it is described that the container moves through a lamp channel which is actuated at the same time per camera recording. In the case of a multiplicity of beverages, however, a rotation of the container about the longitudinal axis thereof in this way is not desired.

EP 20 217 81 A1 describes a method of illumination which is directed towards a suitable testing for faults such as for example foreign bodies in the container and, in particular, also the differentiation of incorrect faults such as raised areas in the glass on the container. In the case of this method the container is illuminated with different light colours from different directions. One light colour should illuminate the container as well as the filled material (so-called transmitted light) and where appropriate the impurity in the product. The other light colour, which acts as incident light, should only illuminate the outer face inclined with respect to the camera and should indicate the raised areas in the glass. The problem can arise in this case, however, that the raised area in the glass is likewise indicated bright by the transmitted light like the foreign object present in the product. In this case the additional incident light is intended to contribute to only the impression in the glass being shown bright in order to permit a differentiation between the raised area in the glass, the impression in the glass and the foreign object. This method is relatively complicated, however, and is frequently also difficult to evaluate.

In addition, it has been found in the past that, in particular, products containing CO₂ such as beer, cola, lemonade and others can produce fine gas bubbles during the rotation about the individual axis depending upon the content of CO₂ and the degree of dissolution of CO₂ in the product. These gas bubbles move in the same way as possible foreign bodies in the product. In this case it is not possible in the prior art to differentiate between gas bubbles and foreign bodies. This can result in removal from the process on account of gas bubbles and not on account of foreign bodies. In principle it would be possible to counteract this situation by a long residence time between the filling and the inspection, but this would lead to long conveying paths and very large mass conveyors. This in turn would be very expensive or even not subsequently possible to achieve.

In addition, it is known for some products to contain non-dissolved organic portions as a result of their origin or by the production process thereof. In this way, it is known for example that residues or even—intentionally—pieces of fruit are present in juices, residues from the production—which have not been filtered out—are present in beers, or parts which are in part not dissolved, such as for example the yeast in naturally cloudy wheat beer. Even if these particles are not perceptible to the human eye, they can act as condensation points for example when the container is turned about its own axis, so that in this case too gas bubbles occur. Both of the named bodies in the liquid, both the gas bubbles and the non-dissolved organic portions in the product, are visible in the inspection and move in exactly the same way as fragments of glass in the product and cannot therefore be differentiated from fragments of glass and other undesired foreign bodies.

In addition, the size and the shape of these respective “impurities” do not differ at first from fragments of glass in the camera. These bodies, however, do not represent any deficiency in the filled product or they are even part of this product.

It may be desirable to provide an apparatus and a method which will permit a better separation between the foreign bodies such as fragments of glass on the one hand and bodies such as air bubbles or even small pieces of fruit which is consciously or intentionally present in the product on the other hand. In particular, fragments of glass represent a considerable defect which goes as far as the risk of injury to the health.

### SUMMARY

According to various aspects of the disclosure, an apparatus for the inspection of filled containers has a first radiation device which directs radiation onto the container to be tested—expressed in more precise terms the liquid to be tested and present in the container—as well as an image-recording device which records at least part of the radiation directed from the first radiation device onto the container or the contents of the container and reflected or scattered by the container—in general the radiation deflected by the liquid. In this case the image-recording device is designed for recording a spatially resolved image.

According to the disclosure the apparatus has at least one further radiation device or one further image-recording device, the radiation device and the image-recording device being arranged in such a way that a recording of the radiation directed onto the liquid and reflected or scattered by the liquid is carried out on at least two image-recording paths which are different from each other. Expressed in more precise terms, that radiation is observed which has been deflected by the liquid, i.e. the (radiation) direction thereof has been changed by the liquid. In this case this deflection can occur as a result of a reflection or even as a result of scattering.

It may therefore be preferable for the radiation to be directed in particular onto the liquid present in the container. It may be advantageous for the container to be a container which has already been closed.

It is therefore proposed to fix at different positions the light scattered and reflected by the container and the liquid respectively. In this case it is possible for example for two radiation devices to be arranged at different positions and for the radiation to be directed onto the container or the contents of the container respectively and for the light reflected and/or scattered in each case by the contents of the container to be recorded by the image-recording device.

Accordingly, it would also be possible for only one radiation device to be provided as well as two image-recording devices, which are arranged at different positions with respect to the container. On account of this procedure it is possible for particles, in particular particles specific to the product, which are present inside the liquid and which are characteristic of the liquid, to be differentiated from foreign bodies present in the liquid.

In this way it is possible for example for non-dissolved organic constituents and gas bubbles on the one hand (i.e. particles characteristic of the liquid) to be differentiated from fragments of glass (i.e. foreign bodies) on the other hand. In this case it should be taken into consideration that the former constituents and also gas bubbles scatter in all directions the light striking them. This means that, irrespectively of the direction from which they are being irradiated with light, these constituents always scatter. Expressed in more precise terms, the boundary transition from the gas bubbles to the liquid has a high optical refractive index, in which case light is scattered in all directions as a result of the spherical shape. For this reason the gas bubbles are always seen when they are irradiated with light. Non-dissolved organic solid substances which are irradiated with light scatter the incident light in a diffuse manner. This means that even these solid substances are always seen when they are irradiated with light.

The fragments of glass, on the other hand, have a low refractive index at their boundary transition with the liquid. If fragments of glass are therefore irradiated with light, the latter is not deflected, but only in favourable positions from light orientation, shape of the fragments of glass and the observation point, of the image-recording direction, the light is deflected by way of the fragments of glass towards the observer. If the light now occupies different paths, the fragments of glass arrive at the image-recording device only in the case of one of these arrangements. If the light is therefore supplied from a multiplicity of directions, but light does not strike the observer directly, then the probability of finding a suitable arrangement for detecting the fragments is greater.

It may be advantageous for the light to pass through the liquid on a plurality of image-recording paths, it potentially being advantageous for at least three, in some aspects at least four, and in some aspects at least six, paths to be provided.

In addition, it would also be possible for a radiation device to be moved and for a multiplicity of recordings to be made during the movement or even for a video to be recorded during which a reflex of the fragment temporarily appears. In addition, it would also be possible for m radiation devices and n image-recording devices to be provided, so that the light can be observed on n×m image-recording paths.

The term “image-recording path” is to be understood as meaning that path of the radiation which the latter occupies starting from the radiation device by way of the liquid to the image-recording device. The term “different image-recording paths” is to be understood as meaning image-recording paths which differ from one another in at least one portion. It may be preferable for two different image-recording paths to differ either in that portion which leads from the radiation device to the liquid to be tested (in particular, if two different radiation devices are used), or in that portion which leads from the liquid to be tested to the image-recording device (in particular, if two different image-recording devices are used).

It may be advantageous therefore for the apparatus to be designed in such a way that no radiation can reach directly from the radiation device to the image-recording device. In this way it would be possible for these two elements to be separated from each other. The liquid may be advantageously observed over at least one image-recording path, and maybe advantageously over all the image-recording paths, with incident light.

In this way, use is made of these properties as described above, in which case solid substances and gas bubbles are always seen, irrespectively of the direction from which the light is coming, and fragments of glass is seen only with light from an optimum direction for the observer and the fragments. In this case therefore an observation at least two different angles takes place in each case.

In the case of an exemplary embodiment the apparatus has two radiation devices. These illuminate the container or the contents thereof from different directions in this case and the image-recording device records the light arriving from these different directions in each case.

In the case of an exemplary embodiment the apparatus has a control device which has the effect that image recordings are made over the different recording paths within a time span which is less than 500 μs, in some aspects less than 300 μs, and in some aspects less than 100 μs. In this way it is possible for a plurality of recordings of the container or the contents thereof to be made at substantially the same moment, in which case each recording is made with light from a different direction. The relatively small time interval between the recordings may be advantageous since even for example gas bubbles and non-dissolved constituents inside the liquid change their position in the course of time and for this reason the recorded images could also be differentiated.

In the case of an exemplary embodiment the apparatus has a comparator device which compares the two images—recorded over different recording paths—with each other. In this way it is possible for the recordings to be compared with each other and for the points—which become visible in a plurality of recordings, i.e. at least two recordings—to be assigned to the category of glass bubbles or solid substance. If a point is visible in one recording and not in another, this can be assigned to the category of a fragment of glass.

In the simplest case a set of recordings at one moment in time is sufficient. If the differentiation of fragments of glass from bulges in the glass or the like is required or if the design of the light direction of the containers and the observers has the tendency that the fragment of glass is not clearly recognized with a set of recordings at one moment in time, it is recommended that a plurality of sets of recordings should be made at a multiplicity of moments in time. Whilst the fragment of glass is in motion relative to the observer, the moments in time are freely selected. In this case the container itself can be positioned relative to the observer or the container can always occupy the same position relative to the observer at different moments in time. In this way it would be possible for the container to turn at a pre-set rotational speed and for the recordings to be made with the periods of these revolutions in each case. It may be advantageous for the containers to be glass containers and in particular glass bottles.

In the case of an exemplary embodiment the image-recording device is situated below the container. This may be advantageous inasmuch as the defective parts to be observed, such as fragments, are usually deposited on the base of the container and are therefore capable of being detected in this way.

It may be advantageous for at least one radiation device to illuminate a lateral wall of the container. In the case of the method proposed in this case measuring therefore takes place in the incident-light process, so that only light of this type is always recorded by the image-recording device, which light is deflected by the liquid.

In the case of an exemplary embodiment the apparatus has a conveying device for conveying the containers. In this way, in particular, the radiation devices and the image-recording devices are arranged in a stationary manner and the containers are conveyed past the radiation and the image-recording devices. In this case it is advantageous for the conveying device to be designed in such a way that the base of the containers remains free. It may be advantageous for the conveying devices to have a guide means which guides the containers at their neck. It would also be possible, however, for the guiding device to engage on a lateral wall of the containers.

In the case of an exemplary embodiment at least one image-recording device moves at least locally with the containers to be inspected. In this way, a plurality of image-recording devices for the containers can be arranged for example on a rotatable carrier, as well as a plurality of image-recording devices which move jointly with the containers. In this case it may be advantageous for an image-recording unit to be associated with each of the said holding device[s]. It may be advantageous for precisely one image-recording device to be provided for each container to be inspected, and it may be preferable for perspective images to be recorded only from one pre-set (camera).

The at least one radiation device can likewise move jointly with the containers, but it may be preferable for the at least one radiation device to be arranged in a stationary manner, i.e. for it not to move with the containers. In this case it should be noted that the precise relative position of the radiation device with respect to the moving containers is less critical than the position of the image-recording device.

It may be advantageous for a control device to control the radiation devices in a manner dependent upon a movement of the containers, and, in particular, a movement in the conveying direction of the containers. It may be advantageous for the containers to be conveyed along a straight path. It may be advantageous for the apparatus also to have a position-detection device (such as for example a light barrier) which detects the position of the containers in the conveying direction. In this case it may be preferable for the containers to be individualized, i.e. for that position in the conveying direction to be known to a control device at substantially each moment at which a specified container is just present. In this way an individual removal of specified containers, which or the contents of which is or are recognized as being defective, is possible. An individualization unit of this type can be formed from one or more position-detection devices which (where appropriate by way of a control device) are in communication with the conveying device which conveys the containers.

As mentioned above, the recordings can also be made shortly one after the other, in which case however, the recordings can follow so closely one after the other that the movements of the objects do not play a relevant role. In this case, as mentioned above, it is both possible for one camera as well as a plurality of cameras to be used in order to record images closely one after the other. It would also be possible therefore for both a plurality of cameras to be used and a plurality of radiation devices, or, on the other hand, a movable radiation-recording or image-recording device.

It may be advantageous for the radiation devices to irradiate diffuse light onto the liquid. In this way, it would be possible for light-scattering devices such as matt screens to be arranged between radiation devices and the liquid. It would also be possible, however, for the radiation to be directed onto the liquid indirectly (for example by way of mirrors) and, in addition, it may be advantageously possible for diffractive elements such as lenses or the like to be arranged between the radiation device and the container. In addition, Fresnel lenses could be used in this case.

In this way, an optical means, for example a lens which in particular images that region of the container on the image-recording device in which an increased probability of the occurrence of undesired foreign objects is present, could be provided between the container and the image-recording device. In this way for example, in particular, it would be possible for the base of the container or the portion of the liquid situated above the base to be imaged, since for example fragments of glass are deposited on the base.

In addition, it would be possible, in order to differentiate the light direction, to use different wavelengths. In this way, for example, one radiation device could emit red light and a further radiation device could emit green light. The separation of the recordings with different light directions and wavelengths could be carried out in a recording with a colour camera. In this case it would be possible to have the recordings carried out substantially at the same time. In this case, however, it is difficult to select two light colours which are readily separated and which pass satisfactorily through the product and through the container.

It may be advantageous, however, for the images to be recorded staggered in time, for example with a very small time interval, in particular substantially at the same time.

The present disclosure is further directed to a method of inspecting filled containers and, in particular, of testing filled containers for foreign bodies inside the container, in which the container is illuminated with a first radiation device and the radiation scattered or reflected or generally deflected by the liquid present in the container is recorded at least in part by a first image-recording device, the radiation passing along a first image-recording path from the first radiation device to the image-recording device and the image-recording device recording a spatially resolved image of the radiation striking it. In particular, particles present inside the liquid and specific to the liquid are differentiated as a result from the foreign bodies present in the liquid.

According to the disclosure, the radiation is irradiated along a second image-recording path onto the container and the radiation reflected and/or thrown back by the container and the liquid respectively is also recorded in this case.

As also already mentioned with reference to the apparatus according to the disclosure, in this case too an essential concept is that the liquids are illuminated at different angles or directions and an image is recorded at various different angles. In this way, it is possible to differentiate between the contents of the liquid described in greater detail above.

In the case of an exemplary embodiment the images recorded along the two image-recording paths are recorded with a time span with respect to each other which is less than 500 μs, in some aspects less than 200 μs, and in some aspects less than 100 μs.

It may be advantageous for two images recorded along the two different image-recording paths or recorded by way of the two different image-recording paths also to be compared with each other.

In the case of an exemplary method, an image comparison of the recorded images is evaluated by an evaluation device. In the case of an exemplary method the evaluated image is assigned to a pre-set result. In addition, it is possible for a conclusion to be drawn on the presence of foreign bodies in the liquid from the evaluated image. In this way, for example a differential image between the individual images can be formed in the scope of the evaluation.

Further exemplary embodiments are evident from the accompanying drawings.

### BRIEF DESCRIPTION OF THE DRAWINGS

In the drawings:

FIG. 1 is a view of a portion of a container;

FIG. 2a shows an apparatus according to exemplary aspects of the disclosure in a first observation state;

FIG. 2b shows the apparatus from FIG. 2a in a second observation state;

FIG. 3a shows an image recorded in the state shown in FIG. 2a;

FIG. 3b shows an image recorded in the state shown in FIG. 2b, and

FIG. 4 is an illustration for explaining a procedure according to exemplary aspects of the disclosure.

### DETAILED DESCRIPTION

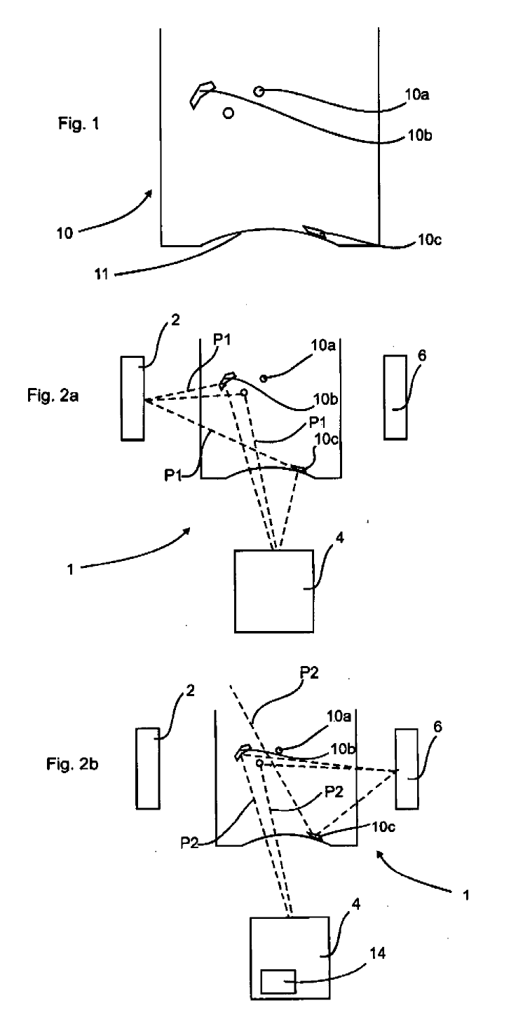

FIG. 1 shows a lower portion of a container 10. A liquid, and in particular a beverage, is already present inside this container. The reference 10a relates to air bubbles which can arise for example in the case of a carbonated beverage. The reference 10b designates suspended substances inside the beverage, such as for example small pieces of fruit. These too are desired. The reference 10c, on the other hand, designates an intrusive body such as for example fragments of glass, which can be present on the base of the container. These foreign bodies are those bodies which are not desired and in the presence of which the containers would have to be discharged. The reference number 11 designates a base of the container 10.

FIG. 2a shows an apparatus according to the disclosure in a first state. In this case the reference number 2 designates a first radiation or illumination device which illuminates the container or the liquid present in the container from the side. An image-recording device 4, which records an image of the radiation reflected or scattered by the liquid or generally of the radiation deflected, is situated below the container. In this case the references P1 relate respectively to the first recording paths which extend here from the first illumination device 2 by way of the individual bodies 10a, 10b, 10c to the image-recording device 4. In addition, a second radiation or illumination device is provided which, however, is not activated in the state shown in FIG. 2a.

FIG. 2b shows a further illumination state in which the first illumination device 2 is not activated, but the second illumination device 6 is. Neither can image-recording paths P2 be seen in each case, but here the image-recording path P2, which strikes the foreign body 10c, no longer arrives at the image-recording device 4 but is deflected in a different direction. The images recorded by the image-recording device 4 are thus differentiated from one another. The reference number 14 designates accordingly a comparator device which compares with one another the images recorded in each case. In addition, the apparatus can have a conveying device (not shown) which conveys the containers in a pre-determined direction, in this case for example at a right angle to the plane of the figures. In addition, walls which prevent the light from passing directly from the radiation device 2 and 6 respectively to the image-recording device 4 can be provided between the radiation devices and the image-recording devices.

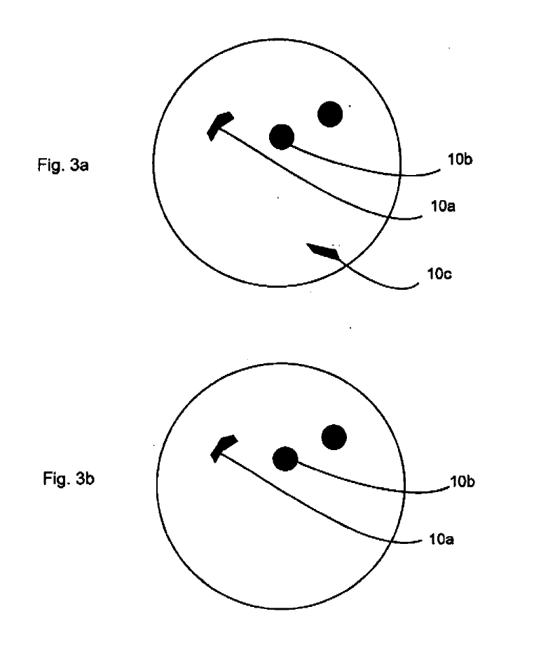

FIGS. 3a and 3b show two recorded images, the image in FIG. 3a being recorded in the state shown in FIG. 2a and the image shown in FIG. 3b being recorded in the state shown in FIG. 2b. It is evident that in the case of the image shown in FIG. 3b the body 10c has not been jointly imaged. In this way it can be established by a comparison of the images shown in FIGS. 3a and 3b that the phenomenon 10c could possibly be a fragment of glass.

It may be preferable for the apparatus shown in FIGS. 2a and 2b also to have in each case an ejection device which in reaction to a comparison performed between the images shown in FIGS. 3a and 3b diverts the corresponding container of which these images were recorded. This ejection device may therefore advantageously communicate with the comparator device 14 which compares with one another the images recorded in each case. The ejection device may be advantageously arranged in this case downstream with respect to the apparatus 1 in the conveying direction of the containers. The containers may be advantageously conveyed individually, for example on a conveyor belt, between the apparatus 1 and the ejection device, there being a certain distance between the individual containers. The ejection device can be for example an impact device which knocks containers recognized as being defective away from the conveying device.

In addition, an apparatus according to the disclosure can also have an image-display unit which displays the images recorded by the image-recording device 4 to a user or even displays two images—shown in the arrangements of FIGS. 2a and 2b—adjacent to each other to the user.

In the case of an exemplary embodiment the apparatus according to the disclosure has a memory device for storing the recorded images. A multiplicity of images of the container or the liquid can be stored in this memory device. The comparator device 14 can, as mentioned above, compare two recorded images with each other, in order to establish in this way whether foreign bodies such as for example fragments of glass are present in the liquid. In this case a comparison can be carried out pixel by pixel between the two images.

An evaluation unit can evaluate the data obtained from the comparator device 14 and can thus decide whether undesired foreign bodies such as fragments of glass or only particles specific to the product are present in the liquid. A container can be discharged for example in reaction to a result displayed by the evaluation unit.

The at least two images may be recorded within a time window of 1-1000 μs, in some aspects 1-500 μs, in some aspects 1-100 μs, in some aspects 1-50 μs, in some aspects 1-20 μs, and in in some aspects 1-10 μs. In this way it is possible to prevent the same particles from appearing at different positions in the two images, and the offset nevertheless occurring by the time difference between the images is negligible. It may be advantageous for only one image-recording device to be provided, in order to record the two images. This means that the two images may be recorded from the same direction. This procedure may afford the advantage that even the contours of the particles can be used for the comparison. In the case of an exemplary embodiment the apparatus can have a rotating device for rotating the containers about the longitudinal axis thereof.

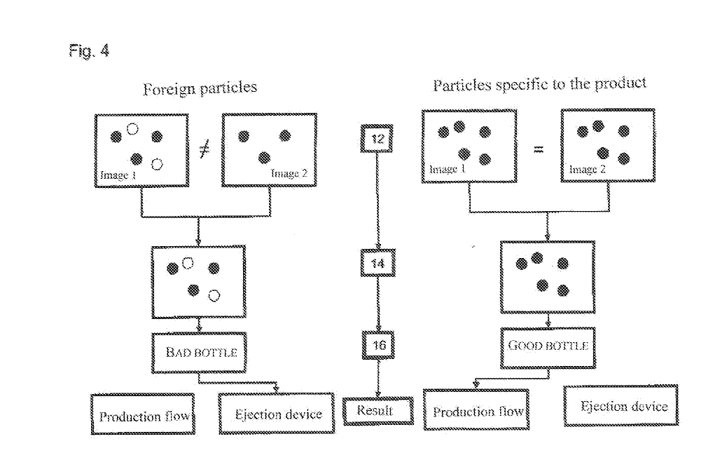

FIG. 4 illustrates the procedure for differentiating foreign bodies such as fragments of glass from desired particles in the liquid. Fragments of glass or other (in particular reflecting) foreign bodies, which are indicated by empty circles, are present in the liquid in the left-hand part of the image. The desired particles specific to the product are indicated by solid circles in the two images.

These images stored in the memory device 12 are compared with one another in the comparator device 14 in each case. In this way it would be possible for image 2 to be removed (in terms of pixels) from image 1 and for image 1 to be removed (in terms of pixels) from image 2. In the first case both parts of the image indicated by empty circles would remain, and in the second case the part of the image indicated by the empty circle. If it is evident from this comparison that these two images do not coincide, foreign bodies such as fragments of glass can be deduced, since the scatter direction (or reflection direction) for these objects is different. In this case a differential image may be advantageously produced. An evaluation device evaluates the corresponding comparisons and displays a result characteristic of this comparison.

In reaction to this result the bottle in question can be discharged. No fragments of glass are present in the right-hand part of the glass, and the recorded images coincide. The container in question can therefore remain in the production flow.

In the case of an exemplary embodiment the image-recording device is designed in such a way that it images (in particular in sharp focus) a region of the liquid inside the container and, in particular, a region of the liquid which is present immediately above the base of the container. In this case this image-recording device can advantageously be designed in such a way that it does not image the base of the container itself in sharp focus. In this way a comparison can be made just with respect to the liquid present in the container. In addition, a previously recorded reference image can be used to remove the container properties or features specific to the container from the currently recorded images of the liquid, if for example the depth of focus of the image-recording device can be set only with difficulty.

It will be apparent to those skilled in the art that various modifications and variations can be made to the apparatus and method of testing filled containers for foreign bodies of the present disclosure without departing from the scope of the invention. Throughout the disclosure, use of the terms “a,” “an,” and “the” may include one or more of the elements to which they refer. Other embodiments of the invention will be apparent to those skilled in the art from consideration of the specification and practice of the invention disclosed herein. It is intended that the specification and examples be considered as exemplary only.

What is claimed is:

1. A method of inspecting filled containers, comprising:
Illuminating liquid present in a container with a first radiation device;
recording at least part of the radiation being at least one of scattered and reflected by the liquid present in the container with an image-recording device, the radiation passing along a first image-recording path from the first radiation device to the image-recording device, and the image-recording device recording a spatially resolved image of the radiation striking it;
irradiating radiation along a second image-recording path onto the container; and
recording the radiation being at least one of reflected and thrown back by the container in order to differentiate particles present inside the liquid and specific to the liquid from foreign bodies present in the liquid.

2. A method according to claim 1, wherein the images recorded along the first and second image-recording paths are recorded with a time span with respect to each other which is less than 500 μs.

3. A method according to claim 2, wherein the images recorded along the first and second image-recording paths are recorded with a time span with respect to each other which is less than 200 μs.

4. A method according to claim 3, wherein the images recorded along the first and second image-recording paths are recorded with a time span with respect to each other which is less than 100 μs.

5. A method according to claim 1, further comprising comparing the images recorded along the first and second image-recording paths with each other.

6. A method according to claim 5, wherein the image comparison of the recorded images is evaluated by an evaluation device.

7. A method according to claim 6, wherein the evaluated image is assigned to a pre-set result.

8. An apparatus for the inspection of filled containers, comprising:
a first radiation device which directs radiation onto a liquid to be tested and present in a container;
an image-recording device which records at least part of the radiation directed from the first radiation device onto the liquid and reflected or scattered by the container, the image-recording device being designed for recording a spatially resolved image; and
a second radiation device which directs radiation onto a liquid to be tested and present in the container; the first and second radiation devices and the image-recording device being arranged in such a way that an observation of the liquid is carried out on at least two image-recording paths which are different from each other.

9. An apparatus according to claim 8, further comprising a control device configured to record images made over the different recording paths within a time span which is less than 500 μs.

10. An apparatus according to claim 9, wherein the time span is less than 300 μs.

11. An apparatus according to claim 10, wherein the time span is less than 100 μs.

12. An apparatus according to claim 8, further comprising a comparator device that compares the two images recorded over different recording paths with each other.

13. An apparatus according to claim 8, wherein the image-recording device is situated below the container.

14. An apparatus according to claim 8, wherein at least one of said radiation devices illuminates a lateral wall of the container.

15. An apparatus according to claim 8, further comprising a conveying device for conveying the containers.

16. An apparatus for the inspection of filled containers, comprising:
a radiation device which directs radiation onto a liquid to be tested and present in a container;
a first image-recording device which records at least part of the radiation directed from the first radiation device onto the liquid and reflected or scattered by the container, the image-recording device being designed for recording a spatially resolved image; and
a second image-recording device, wherein the radiation device and the first and second image-recording devices are arranged in such a way that an observation of the liquid is carried out on at least two image-recording paths which are different from each other.
